(19) United States
(12) Patent Application Publication
(10) Pub. No.: US 2017/0085626 A1
(43) Pub. Date: Mar. 23, 2017

(54) METHOD AND SYSTEM FOR TRANSFERRING NARROW DATA

(71) Applicant: Sheng-Fu Chang, Taichung (TW)

(72) Inventor: Sheng-Fu Chang, Taichung (TW)

(21) Appl. No.: 15/177,172

(22) Filed: Jun. 8, 2016

(30) Foreign Application Priority Data
Sep. 21, 2015 (CN) 201510602955.9

(51) Int. Cl. H04L 29/08; H04L 29/06

(52) U.S. Cl. CPC H04L 67/10; H04L 67/145; H04L 67/42

(57) ABSTRACT

A system for transferring narrow data includes a coordinator server, relay servers, a device and a client. The system executes a method for transferring narrow data. In the method, the device checks a list of existing relay servers with the coordinator server. The device picks some of the existing relay servers that respond thereto and provides a list of available relay servers to the coordinator server. The device periodically sends packets to the available relay servers to keep the connection to the available relay servers. The client inquires the coordinator server for the list of available relay servers to facilitate the client to connect to the device via at least one of the available relay servers.

### BACKGROUND OF INVENTION

1. Field of Invention

The present invention relates to the internet of things and intelligent homes and, more particularly, to a method and system for transferring narrow data.

2. Related Prior Art

Conventionally, point-to-point (“PTP”) transfer is used for transferring narrow data. The use of the PTP transfer is however not without any problem. Firstly, it takes several to tens of seconds to build a P2P conversation. Hence, the PTP transfer is not effective for instant messaging. Secondly, the PTP transfer requires a high-level operation system such as Multi-Thread and high-level hardware including a CPU and a memory. Hence, the cost of device is high.

Alternatively, a centralized cloud calculation center can be used. Exchange of messages between equipment and users is handled in a large cloud host. The use of the centralized cloud calculation center is not without any problem. Firstly, to support a large amount of equipment and users, the large centralized cloud calculation center includes thousands or tens of thousands of arrays to execute necessary tasks. It takes a lot of man-hours and costs a lot of money to build such hardware and software. Hence, this measure is far beyond the reach of a medium, small or personal business. Secondly, such a centralized architecture does not respond to requests faster than a decentralized architecture.

There are some other methods for transferring narrow data. For example, Location-based dynamic DNS can be used. That is, the IP of a server using a same domain name but located in a different region is used to receive or transfer messages between device and clients. Thus, work load is distributed, and fast response is achieved. However, in a global use, a user may not be able to use a device left at home of in office when the user leaves for another place.

The present invention is therefore intended to obviate or at least alleviate the problems encountered in prior art.

### SUMMARY OF INVENTION

It is the primary objective of the present invention to provide an instant, effective and affordable method and system for transferring narrow data.

To achieve the foregoing objectives, the system includes a coordinator server, relay servers, a device and a client. In the method, the device checks a list of existing relay servers with the coordinator server. The device picks some of the existing relay servers that respond thereto and provides a list of available relay servers to the coordinator server. The device periodically sends packets to the available relay servers to keep the connection to the available relay servers. The client inquires the coordinator server for the list of available relay servers to facilitate the client to connect to the device via at least one of the available relay servers.

In another aspect, between the step of using the device to periodically send packets and the step of using the client to inquire for the list of available relay servers, the method further includes the step of updating the list of available relay servers in the coordinator server if there is any change in any of the available relay servers.

In another aspect, the step of updating the list of available relay servers in the coordinator server includes the step of using the device to update the list of available relay servers.

In another aspect, before the step of using the device to check the list of existing relay servers, the method further includes the step of connecting the relay servers to the coordinator server to actuate the coordinator server to provide the list of existing relay servers.

In another aspect, the step of using the device to check the list of existing relay servers includes the step of building the list of existing relay servers in the coordinator server.

In another aspect, after the step of inquiring for the list of the available relay servers, the method further includes the step of sending data to the device from the client via the relay servers and the step of using the device to respond to the client via the relay servers.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a system for transferring narrow data according to the preferred embodiment of the present invention; and

FIG. 2 is a flow chart of a method for transferring narrow data according to the preferred embodiment of the present invention.

### DETAILED DESCRIPTION OF PREFERRED EMBODIMENT

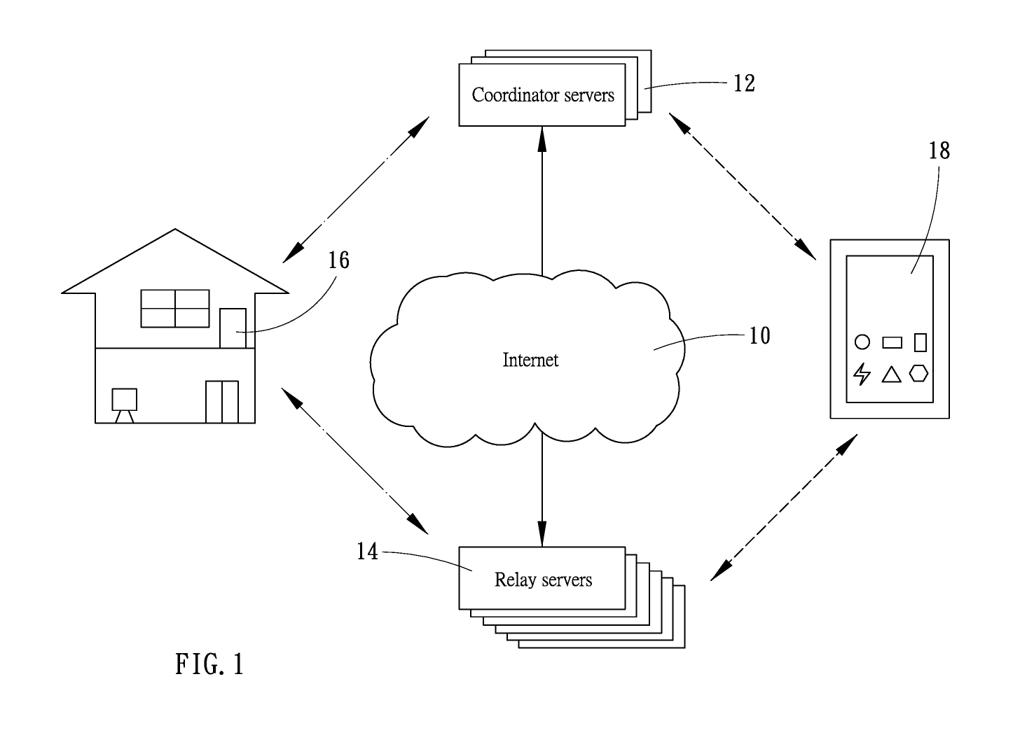

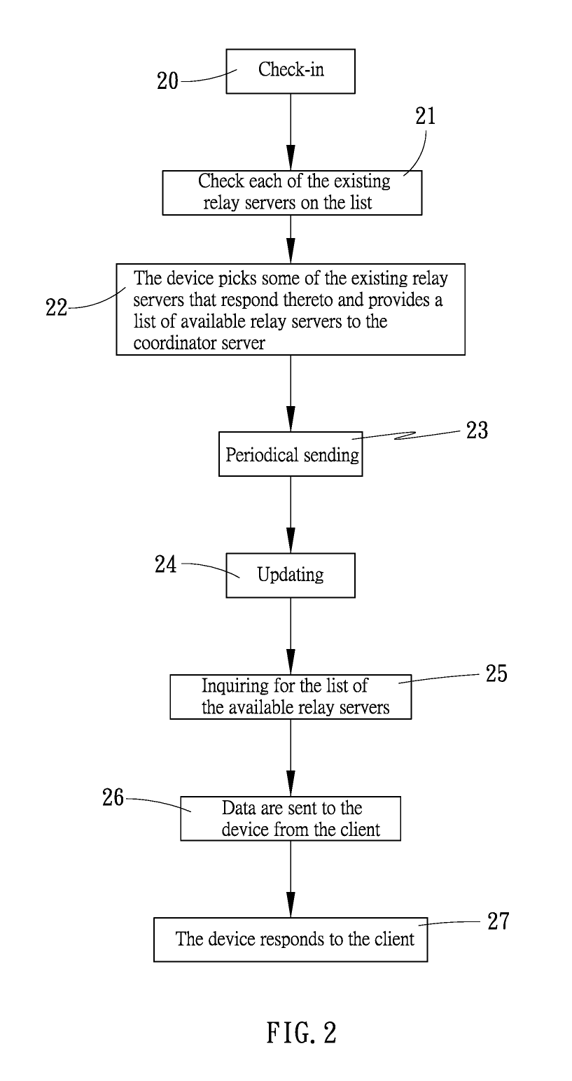

Referring to FIGS. 1 and 2, there is shown a system and method for transferring narrow data according to the preferred embodiment of the present invention. The system shown in FIG. 1 is used to execute the method shown in FIG. 2. The system includes at least one coordinator server 12, a plurality of relay servers 14, a device 16 and a client 18, in the internet 10.

Preferably, the system includes a group of coordinator servers 12. Alternatively, the group of coordinator servers 12 can be a group of two or any other proper number of coordinator servers 12. Each of the coordinator servers 12 can work alone and be used as a backup for any other coordinator server 12. The group of coordinator servers 12 provides a list of existing relay servers 14 and a list of available relay servers 14. The list of existing relay servers 14 can be built in the group of coordinator server 12 or obtained according to the following method for transferring narrow data.

The relay servers 14 are sorted to various groups and included in the list of existing relay servers 14 by the group of coordinator servers 12. Briefly speaking, based on regions, the relay servers 14 can be sorted to Asian, American and European groups. In the Asian group for example, the amount of the relay servers 14 can be increased if the amount of clients 18 is increased. In the American group for example, the amount of the relay servers 14 can be reduced if the amount of clients 18 is reduced.

The device 16 can be a host that includes an application program interface (“API”) for controlling electric appliances or electronic devices such as lamps and air conditioners. Thus, the brightness of such a lamp or the volume and/or temperature of such an air conditioner are under control.

The client 18 can be a device for communication such as a smart phone that includes an API.

It should be noted that the client 18 and the device 16 are linked to the internet 10 via a router (not shown). Moreover, the internet IPs of the client 18 and the device 16 can be floating, i.e., they can be changed after a period of time.

Then, the method for transferring narrow data will be described. Firstly, at 20, check-in is executed. All of the relay servers 14 contact the group of coordinator servers 12. Accordingly, the group of coordinator server 12 provides a list of existing relay servers 14.

For check-in, each of the relay servers 14 sends packets to the group of coordinator servers 12 to provide data such as the identities of the relay servers 14 and the names of the groups in which the relay servers 14 belong. Periodically, the relay servers 14 execute the check-in. The time interval between two rounds of check-in is adjustable.

For example, fifteen (15) relay servers 14 check in with the group of coordinator servers 12. The group of coordinator servers 12 accordingly provides a list of existing relay servers 14, including all of the data about the relay servers 14 such as the identities of the relay servers 14 and the names of the groups in which the relay servers 14 belong.

However, the check-in of the existing relay servers 14 can be skid if the list of existing relay servers 14 has already been built in the group of coordinator servers 12.

At 21, each of the existing relay servers 14 on the list is checked. The device 16 checks each of the existing relay servers 14 on the list with the group of coordinator servers 12.

At 22, at least some of the existing relay servers 14 respond to the group of coordinator servers 12. The device 16 picks those relay servers 14 that respond thereto as available relay servers 14, and provides a list of available relay servers 14 to the group of coordinator servers 12.

For example, the device 16 sends the packets to all of the existing relay servers 14 on the list, and only relay server Nos. 2, 3, 5, 8 and 10 respond to the device 16. The device 16 provides the list of available relay servers 14 to the group of coordinator servers 12 to overwrite the previous list of available relay servers 14. Thus, the group of coordinator servers 12 always includes the latest list of available relay servers 14.

At 23, periodical sending is executed. The device 16 periodically sends packets to each of the available relay servers 14 on the list. Thus, the connection is retained.

The device 16 is connected to relay server Nos. 2, 3, 5, 8 and 10 via routers. These relay servers 14 respond to the device 16 via the routers to keep the connection via the routers.

At 24, updating is executed. The device 16 provides another list of available relay servers 14 to the group of coordinator servers 12 if there is any change in any of the available relay servers 14. Thus, the list of available relay servers 14 is updated.

For example, relay server No. 3 is suddenly interrupted. Now, the device 16 rewrites the list of available relay servers 14 to list relay server Nos. 2, 5, 8 and 10, and provides the group of coordinator servers 12 with the latest list of available relay servers 14.

At 25, inquiring for the list of the available relay servers 14 is executed. The client 18 inquires the group of coordinator servers 12 for the list of available relay servers 14. The group of coordinator server 12 provides the client 18 with the latest list of available relay servers 14 to let the client 18 know the way to connect to the device 16.

At 26, data are sent to the device 16 from the client 18. The client 18 provides the available relay servers 14 with data for the device 16, and the relay servers 14 transfer the data to the device 16.

At 27, the device 16 responds to the client 18. The device 16 responds to the client 18 via the relay servers 14.

For example, the client 18 transfers the data to the device 16 via relay server Nos. 2, 5, 8 and 10, and the device 16 responds to the client 18 via relay server Nos. 2, 5, 8 and 10.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for transferring narrow data comprising the steps of:
providing a coordinator server, relay servers, a device and a client;
using the device to check a list of existing relay servers with the coordinator server;
using the device to pick some of the existing relay servers that respond thereto and provide a list of available relay servers to the coordinator server;
using the device to periodically send packets to the available relay servers to keep the connection to the available relay servers; and
using the client to inquire the coordinator server for the list of available relay servers to facilitate the client to connect to the device via at least one of the available relay servers.

2. The method according to claim 1, between the step of using the device to periodically send packets and the step of using the client to inquire for the list of available relay servers, further comprising the step of updating the list of available relay servers in the coordinator server if there is any change in any of the available relay servers.

3. The method according to claim 2, wherein the step of updating the list of available relay servers in the coordinator server comprises the step of using the device to update the list of available relay servers.

4. The method according to claim 1, before the step of using the device to check the list of existing relay servers, further comprising the step of connecting the relay servers to the coordinator server to actuate the coordinator server to provide the list of existing relay servers.

5. The method according to claim 1, wherein the step of using the device to check the list of existing relay servers comprises the step of building the list of existing relay servers in the coordinator server.

6. The method according to claim 1, after the step of inquiring for the list of the available relay servers, further comprising the steps of:
sending data to the device from the client via the relay servers; and
using the device to respond to the client via the relay servers.
